(19) United States
(12) Patent Application Publication
(10) Pub. No.: US 2026/0153714 A1
(43) Pub. Date: Jun. 4, 2026

(54) OPTICAL IMAGING SYSTEM

(71) Applicant: Samsung Electro-Mechanics Co., Ltd., Suwon-si (KR)

(72) Inventors: Jae Hyuk HUH, Suwon-si (KR); You Jin JEONG, Suwon-si (KR); So Mi YANG, Suwon-si (KR); Soo Bin HA, Suwon-si (KR)

(73) Assignee: Samsung Electro-Mechanics Co., Ltd., Suwon-si (KR)

(21) Appl. No.: 19/344,782

(22) Filed: Sep. 30, 2025

(30) Foreign Application Priority Data
Nov. 29, 2024 (KR) 10-2024-0174945
Jul. 25, 2025 (KR) 10-2025-0101494

(51) Int. Cl. G02B 13/00; G02B 9/64; G02B 13/02

(52) U.S. Cl. CPC G02B 13/0065; G02B 9/64; G02B 13/0045; G02B 13/02

(57) ABSTRACT

An optical imaging system includes a plurality of lenses sequentially disposed along an optical axis of the optical imaging system from an object side of the plurality of lenses toward an imaging plane of the optical imaging system; and a reflective member disposed in front of the plurality of lenses and including a reflective surface, wherein the plurality of lenses includes a first lens disposed closest to the reflective member, and a second lens disposed adjacent to the first lens on an image side of the first lens, a composite focal length f12 of the first lens and the second lens has a positive value, and a conditional expression 0.9<|(R1+R2)/(R1−R2)|<1.1 is satisfied, where R1 is a radius of curvature of an object-side surface of the first lens, and R2 is a radius of curvature of an image-side surface of the first lens.

### CROSS-REFERENCE TO RELATED APPLICATIONS

This application claims the benefit under 35 USC 119 (a) of Korean Patent Application Nos. 10-2024-0174945 filed on Nov. 29, 2024, and 10-2025-0101494 filed on Jul. 25, 2025, in the Korean Intellectual Property Office, the entire disclosures of which are incorporated herein by reference for all purposes.

### BACKGROUND

### 1. Field

The present disclosure relates to an optical imaging system.

### 2. Description of Background

Recently, a portable terminal includes a camera including an optical imaging system comprised of a plurality of lenses that can make video calls and capture images.

In addition, as the function occupied by a camera in a portable terminal gradually increases, the demand for a camera for a portable terminal having high resolution is increasing.

In addition, since the portable terminal is gradually being miniaturized and the camera for the portable terminal is also required to be slimmed, the development of an optical imaging system for implementing high resolution while being slim is required.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a plurality of lenses sequentially disposed along an optical axis of the optical imaging system from an object side of the plurality of lenses toward an imaging plane of the optical imaging system; and a reflective member disposed in front of the plurality of lenses and including a reflective surface, wherein the plurality of lenses includes a first lens disposed closest to the reflective member, and a second lens disposed adjacent to the first lens on an image side of the first lens, a composite focal length f12 of the first lens and the second lens has a positive value, and a conditional expression 0.9<|(R1+R2)/(R1−R2)|<1.1 is satisfied, where R1 is a radius of curvature of an object-side surface of the first lens at the optical axis, and R2 is a radius of curvature of an image-side surface of the first lens at the optical axis.

A conditional expression 500 mm<|R1| may be satisfied.

The object-side surface of the first lens may be flat in at least a paraxial region thereof.

An entire object-side surface of the first lens may be flat.

A conditional expression 25<|R1/f| may be satisfied, where f is a total focal length of the optical imaging system.

A conditional expression 1.00<TTL/(2×IMG HT)<1.70 may be satisfied, where TTL is a distance along the optical axis from the object-side surface of the first lens to the imaging plane, and IMG HT is one half of a diagonal length of the imaging plane.

A conditional expression 0.95<TTL/f<1.3 may be satisfied, where TTL is a distance along the optical axis from the object-side surface of the first lens to the imaging plane, and f is a total focal length of the optical imaging system.

The plurality of lenses may further include a third lens disposed adjacent to the second lens on an image side of the second lens, and a conditional expression 12<|v1−Avg(v2,v3)|<35 may be satisfied, where v1 is an Abbe number of the first lens, and Avg(v2,v3) is an average value of an Abbe number of the second lens and an Abbe number of the third lens.

The plurality of lenses may further include a third lens disposed adjacent to the second lens on an image side of the second lens, and a conditional expression 3.15<n2+n3<3.4 may be satisfied, where n2 is a refractive index of the second lens, and n3 is a refractive index of the third lens.

The plurality of lenses may further include a third lens disposed adjacent to the second lens on an image side of the second lens, and a conditional expression 3.3<|f/f2+f/f3|<7.0 may be satisfied, where f2 is a focal length of the second lens, f3 is a focal length of the third lens, and f is a total focal length of the optical imaging system.

A conditional expression −3.00<f−TTL_2<1.00 may be satisfied, where f is a total focal length of the optical imaging system, and TTL_2 is a distance along the optical axis from an object-side surface of the second lens to the imaging plane.

A conditional expression 0.3<|f1/f|<3.1 may be satisfied, where f1 is a focal length of the first lens, and f is a total focal length of the optical imaging system.

A conditional expression 0.2<|f1/f2|<6.0 may be satisfied, where f1 is a focal length of the first lens, and f2 is a focal length of the second lens.

A conditional expression 0.3<f12/f<1.0 may be satisfied, where f12 is a composite focal length of the first lens and the second lens, and f is a total focal length of the optical imaging system.

A conditional expression 0.002<D1/f<0.03 may be satisfied, where D1 is a distance along the optical axis between an image-side surface of the first lens and an object-side surface of the second lens.

The second lens may have a positive refractive power.

The plurality of lenses may further include a third lens, a fourth lens, and a fifth lens, the first lens, the second lens, the third lens, the fourth lens, and the fifth lens may be sequentially disposed in ascending numerical order along the optical axis from an object side of the first lens toward the imaging plane, and the second lens may have a positive refractive power, and the fifth lens may have a negative refractive power.

The plurality of lenses may further include a third lens, a fourth lens, a fifth lens, and a sixth lens, the first lens, the second lens, the third lens, the fourth lens, the fifth lens, and the sixth lens may be sequentially disposed in ascending numerical order along the optical axis from an object side of the first lens toward the imaging plane, and the second lens may have a positive refractive power, the fourth lens may have a positive refractive power, the fifth lens may have a negative refractive power, and the sixth lens may have a positive refractive power.

The plurality of lenses may further include a third lens, a fourth lens, a fifth lens, a sixth lens, and a seventh lens, the first lens, the second lens, the third lens, the fourth lens, the fifth lens, the sixth lens, and the seventh lens may be sequentially disposed in ascending numerical order along the optical axis from an object side of the first lens toward the imaging plane, and the first lens may have a negative refractive power, the second lens may have a positive refractive power, the third lens may have a negative refractive power, the fourth lens may have a positive refractive power, the fifth lens may have a positive refractive power, and the seventh lens may have a negative refractive power.

Other features and aspects will be apparent from the following detailed description, the drawings, and the claims.

### BRIEF DESCRIPTION OF DRAWINGS

FIG. 1 is a configuration diagram of an optical imaging system according to a first embodiment of the present disclosure.

FIG. 2 is a diagram illustrating aberration characteristics of the optical imaging system illustrated in FIG. 1.

FIG. 3 is a configuration diagram of an optical imaging system according to a second embodiment of the present disclosure.

FIG. 4 is a diagram illustrating aberration characteristics of the optical imaging system illustrated in FIG. 3.

FIG. 5 is a configuration diagram of an optical imaging system according to a third embodiment of the present disclosure.

FIG. 6 is a diagram illustrating aberration characteristics of the optical imaging system illustrated in FIG. 5.

FIG. 7 is a configuration diagram of an optical imaging system according to a fourth embodiment of the present disclosure.

FIG. 8 is a diagram illustrating aberration characteristics of the optical imaging system illustrated in FIG. 7.

FIG. 9 is a configuration diagram of an optical imaging system according to a fifth embodiment of the present disclosure.

FIG. 10 is a diagram illustrating aberration characteristics of the optical imaging system illustrated in FIG. 9.

FIG. 11 is a configuration diagram of an optical imaging system according to a sixth embodiment of the present disclosure.

FIG. 12 is a diagram illustrating aberration characteristics of the optical imaging system illustrated in FIG. 11.

FIG. 13 is a configuration diagram of an optical imaging system according to a seventh embodiment of the present disclosure.

FIG. 14 is a diagram illustrating aberration characteristics of the optical imaging system illustrated in FIG. 13.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the configuration diagrams in the drawings, the thickness, size, and shape of the lenses may be somewhat exaggerated for clarity of explanation, and in particular, the aspherical shape of the lenses in the configuration diagrams is only an example, and is not limited thereto.

An optical imaging system according to an embodiment of the present disclosure may be mounted on a portable electronic device. For example, the optical imaging system may be a component of a camera module mounted on a portable electronic device. A portable electronic device may be a portable electronic device such as a mobile communication terminal, a smartphone, a tablet PC, or any other portable electronic device.

In the present specification, all numerical values of a radius of curvature, a thickness, a distance, a focal length, and other dimensions are expressed in millimeters, and a field of view (FOV) is expressed in degrees.

In addition, in a description of a shape of a lens, a statement that a surface of a lens is convex means that a paraxial region of the surface is convex, and a statement that a surface of a lens is concave means that a paraxial region of the surface is concave.

Accordingly, even when it is stated that a surface of a lens is convex, an edge portion of the surface may be concave. Similarly, even when it is stated that a surface of a lens is concave, an edge portion of the surface may be convex.

In addition, in a description of a shape of a lens, a statement that a surface of a lens is flat means that a paraxial region of the surface is flat.

Accordingly, even when it is stated that a surface of a lens is flat, an edge portion of the surface may be convex or concave. Alternatively, the entire surface may be flat.

A paraxial region of a lens surface is a very narrow region of the lens surface near an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈0, tan θ≈θ, and cos θ≈1 are valid.

An imaging plane may refer to an imaginary plane on which a focus is formed by an optical imaging system. Alternatively, the imaging plane may refer to surface of an image sensor on which light is received through the optical imaging system.

An optical imaging system according to an embodiment of the present disclosure includes a plurality of lenses sequentially disposed along an optical axis of the optical imaging system from an object side of the plurality of lenses toward an imaging plane of the optical imaging system. For example, the optical imaging system may include at least five lenses.

In an embodiment, the optical imaging system may include a first lens, a second lens, a third lens, a fourth lens, and a fifth lens sequentially disposed along an optical axis of the optical imaging system from an object side of the first lens toward an imaging plane of the optical imaging system.

In an embodiment, the optical imaging system may include a first lens, a second lens, a third lens, a fourth lens, a fifth lens, and a sixth lens sequentially disposed along an optical axis of the optical imaging system from an object side of the first lens toward an imaging plane of the optical imaging system.

In an embodiment, the optical imaging system may include a first lens, a second lens, a third lens, a fourth lens, a fifth lens, a sixth lens, and a seventh lens sequentially disposed along an optical axis of the optical imaging system from an object side of the seventh lens toward an imaging plane of the optical imaging system.

The plurality of lenses included in the optical imaging system may be spaced apart from each other along the optical axis.

The optical imaging system according to an embodiment of the present disclosure may further include a reflective member including a reflective surface for changing a direction of light passing through the optical imaging system. For example, the reflective member may be a mirror or a prism.

In an embodiment, the reflective member may be disposed in front of the first lens. For example, the reflective member may be disposed in front of an object-side surface of the first lens.

When the reflective member is a prism, the reflective member may have any one of the shapes obtained by dividing a rectangular solid (or a cube) into two halves in a diagonal direction. The reflective member may include an incident surface, a reflective surface, and an emission surface. The reflective member has three rectangular surfaces and two triangular surfaces. For example, each of the incident surface, the reflective surface, and the emission surface of the reflective member is rectangular, and both side surfaces of the reflective member are roughly triangular.

External light may be incident on the incident surface of the reflective member, the light incident on the incident surface may be reflected from the reflective surface, and the light reflected from the reflective surface may be emitted from the emission surface. The light emitted from the emission surface may be incident on the first lens.

By bending light using a reflective member, an optical path may be elongated in a relatively narrow space.

Therefore, the optical imaging system may be miniaturized and have a long focal length.

An optical imaging system according to an embodiment of the present disclosure has characteristics of a telephoto lens having a relatively narrow field of view and a long focal length.

In addition, the optical imaging system may further include an image sensor for converting an image of an subject incident on the image sensor into an electric signal.

In addition, the optical imaging system may further include an infrared cut-off filter (hereinafter, referred to as simply as a filter) for blocking infrared rays. The filter may be disposed between a rearmost lens (e.g., a fifth lens, a sixth lens, or a seventh lens) and the image sensor.

Among the plurality of lenses included in the optical imaging system, a first lens disposed closest to an object side of the optical imaging system may have a shape in which an object-side surface of the first lens is flat or substantially flat. For example, a radius of curvature of the object-side surface of the first lens may be formed to be much larger than radius of curvatures of surfaces of the other lenses. A flat surface has a radius of curvature of infinity.

A composite focal length of the first and second lenses may have a positive value.

Among the plurality of lenses included in the optical imaging system, a rearmost lens (e.g., a fifth lens, a sixth lens, or a seventh lens) disposed closest to the imaging plane may have an inflection point on either one or both of an object-side surface and an image-side surface thereof.

A reflective member is disposed in front of the first lens. The reflective member may be rotated about two axes to correct shaking during shooting.

That is, when shaking occurs due to factors such as a user's hand shaking when shooting an image or video, the shaking may be compensated for by rotating the reflective member in response to the shaking.

The reflective member may rotated about two axes that are perpendicular to each other.

In an embodiment, either one or both of an object-side surface and an image-side surface of each of the plurality of lenses included in the optical imaging system may be aspherical.

An aspherical surface of a lens is defined by Equation 1 below.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} \qquad ( 1 )$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H and J are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

An optical imaging system according to an embodiment of the present disclosure may satisfy at least one of the following conditional expressions.

$$1.1 < TTL / ( 2 \times IMG HT ) < 3.1 \qquad ( Conditional Expression 1 )$$

$$12 < \vert v 1 - Avg ( v 2 , v 3 ) \vert < 35 \qquad ( Conditional Expression 2 )$$

$$3.15 < n 2 + n 3 < 3.4 \qquad ( Conditional Expression 3 )$$

$$0.95 < TTL / f < 1.3 \qquad ( Conditional Expression 4 )$$

$$- 3. < f - TTL\_ 2 < 1. \qquad ( Conditional Expression 5 )$$

$$0.3 < \vert f 1 / f \vert < 3.1 \qquad ( Conditional Expression 6 )$$

$$0.2 < \vert f 1 / f 2 \vert < 6. \qquad ( Conditional Expression 7 )$$

$$0.3 < f 12 / f < 1. \qquad ( Conditional Expression 8 )$$

$$3.3 < \vert f / f 2 + f / f 3 \vert < 7. \qquad ( Conditional Expression 9 )$$

$$0.002 < D 1 / f < 0.03 \qquad ( Conditional Expression 10 )$$

$$500 mm < \vert R 1 \vert \qquad ( Conditional Expression 11 )$$

$$25 < \vert R 1 / f \vert \qquad ( Conditional Expression 12 )$$

$$0.9 < \vert ( R 1 + R 2 ) / ( R 1 - R 2 ) \vert < 1.1 \qquad ( Conditional Expression 13 )$$

In an embodiment, the optical imaging system may satisfy a conditional expression 1.10<TTL/(2×IMG HT)<3.10 (Conditional Expression 1), where TTL is a distance along an optical axis from an object-side surface of the first lens to an imaging plane, and IMG HT is one half of a diagonal length of the imaging plane. Therefore, the optical imaging system may be miniaturized while improving a resolution of an image. Preferably, a conditional expression 1.40<TTL/(2×IMG HT)<3.00 may be satisfied. More preferably, a conditional expression 1.498≤TTL/(2×IMG HT)≤2.959 may be satisfied.

In an embodiment, the optical imaging system may satisfy a conditional expression 12<|v1−Avg(v2,v3)|<35 (Conditional Expression 2), where v1 is an Abbe number of the first lens, and Avg(v2,v3) is an average value of an Abbe number of the second lens and an Abbe number of the third lens. Therefore, chromatic aberration may be improved. Preferably, a conditional expression 14.85≤|v1−Avg(v2,v3)|≤34.35 may be satisfied.

In an embodiment, the optical imaging system may satisfy a conditional expression 3.15<n2+n3<3.4 (Conditional Expression 3), where n2 is a refractive index of the second lens, and n3 is a refractive index of the third lens. Therefore, a resolution of an image may be improved and chromatic aberration may be improved. Preferably, a conditional expression 3.158≤n2+n3≤3.325 may be satisfied.

In an embodiment, the optical imaging system may satisfy a conditional expression 0.95<TTL/f<1.3 (Conditional Expression 4), where f is a total focal length of the optical imaging system. Therefore, the optical imaging system may have an appropriate field of view and total track length. Preferably, a conditional expression 1.0048≤TTL/f≤1.2414 may be satisfied.

In an embodiment, the optical imaging system may satisfy a conditional expression −3.0<f−TTL_2<1.0 (Conditional Expression 5), where TTL_2 is a distance along the optical axis from an object-side surface of the second lens to the imaging plane. Therefore, the optical imaging system may be miniaturized. Preferably, a conditional expression −2.8<f−TTL_2<0.8 may be satisfied. More preferably, a conditional expression −2.6204≤f−TTL 2≤0.6287 may be satisfied.

In an embodiment, the optical imaging system may satisfy a conditional expression 0.3<|f1/f|<3.1 (Conditional Expression 6), where f1 is a focal length of the first lens. Therefore, the occurrence of aberration may be minimized by appropriately adjusting a refractive power of the first lens. Preferably, a conditional expression 0.5<|f1/f|<3.05 may be satisfied. More preferably, a conditional expression 0.5372≤|f1/f|≤3.0314 may be satisfied.

In an embodiment, the optical imaging system may satisfy a conditional expression 0.2<|f1/f2|<6.0 (Conditional Expression 7), where f2 is a focal length of the second lens. Therefore, the resolution may be improved by optimizing the focal length of the first lens and the focal length of the second lens. Preferably, a conditional expression 0.3<|f1/f2|<5.8 may be satisfied. More preferably, a conditional expression 0.3241≤|f1/f2|≤5.7438 may be satisfied.

In an embodiment, the optical imaging system may satisfy a conditional expression 0.3<f12/f<1.0 (Conditional Expression 8), where f12 is a composite focal length of the first lens and the second lens. Therefore, the resolution may be improved by optimizing the focal length of the first lens and the focal length of the second lens. Preferably, a conditional expression 0.4<f12/f<0.99 may be satisfied. More preferably, a conditional expression 0.4523≤f12/f≤0.9847 may be satisfied.

In an embodiment, the optical imaging system may satisfy a conditional expression 3.3<|f/f2+f/f3|<7.0 (Conditional Expression 9), where f3 is a focal length of the third lens. Therefore, chromatic aberration may be improved. Preferably, a conditional expression 3.4<|f/f2+f/f3|<6.9 may be satisfied. More preferably, a conditional expression 3.4475≤|f/f2+f/f3|≤6.8886 may be satisfied.

In an embodiment, the optical imaging system may satisfy a conditional expression 0.002<D1/f<0.03 (Conditional Expression 10), where D1 is a distance along the optical axis between an image-side surface of the first lens and an object-side surface of the second lens. Therefore, chromatic aberration may be improved. Preferably, a conditional expression 0.0058≤D1/f≤0.0133 may be satisfied.

In an embodiment, the optical imaging system may satisfy a conditional expression 500 mm<|R1| (Conditional Expression 11), where R1 is a radius of curvature of the object-side surface of the first lens. Therefore, by forming the object-side surface of the first lens to be flat or substantially flat, the optical imaging system may be miniaturized and a degree of design freedom may be increased.

In an embodiment, the optical imaging system may satisfy a conditional expression 25<|R1/f| (Conditional Expression 12). Therefore, by forming the object-side surface of the first lens to be flat or substantially flat, the optical imaging system may be miniaturized and a degree of design freedom may be increased.

In an embodiment, the optical imaging system may satisfy a conditional expression 0.9<|(R1+R2)/(R1−R2)|<1.1 (Conditional Expression 13), where R2 is a radius of curvature of the image-side surface of the first lens. Therefore, the optical imaging system may be miniaturized.

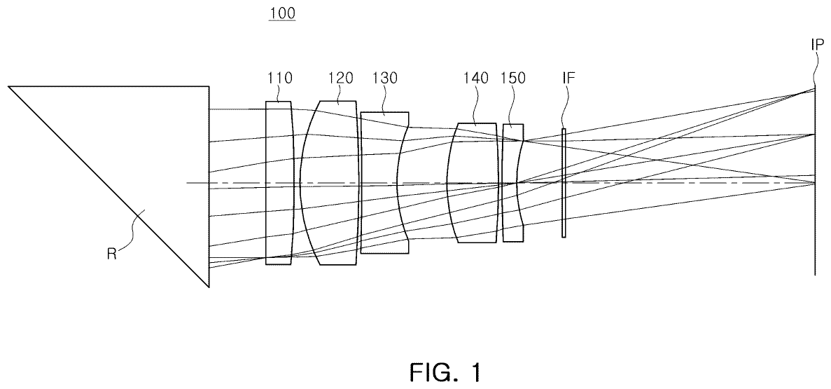

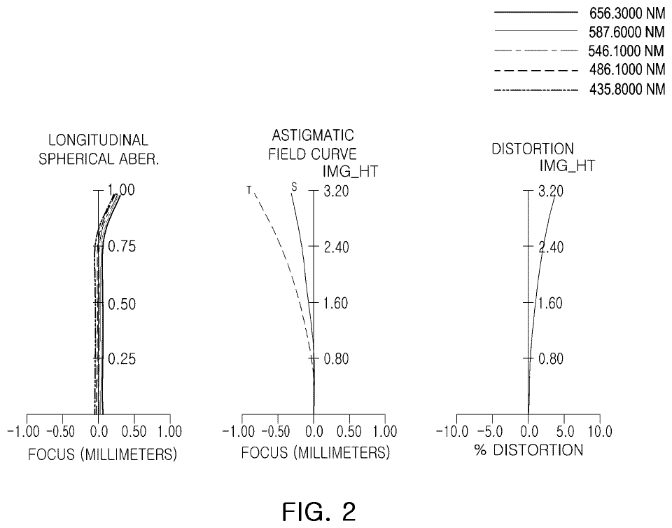

FIG. 1 is a configuration diagram of an optical imaging system according to a first embodiment of the present disclosure, and FIG. 2 is a diagram illustrating aberration characteristics of the optical imaging system illustrated in FIG. 1.

Referring to FIG. 1, an optical imaging system 100 according to the first embodiment of the present disclosure may include an optical system including a first lens 110, a second lens 120, a third lens 130, a fourth lens 140, and a fifth lens 150 sequentially disposed in ascending numerical order along an optical axis of the optical imaging system 100 from an object side of the first lens 110 toward an imaging plane IP. The optical imaging system 100 further includes a reflective member R disposed in front of the first lens 110.

In addition, the optical imaging system 100 may further include a filter IF disposed between the fifth lens 150 and the imaging plane IP, and an image sensor (not shown).

The optical imaging system 100 according to the first embodiment of the present disclosure may form a focus on the imaging plane IP. The imaging plane IP may refer to a surface on which a focus is formed by the optical imaging system 100. For example, the imaging plane IP may refer to one surface of an image sensor (not shown) on which light is received.

In the first embodiment of the present disclosure, the reflective member R may be a prism, but may also be provided as a mirror.

Lens characteristics of each lens (radiuses of curvature, a thickness of a lens or a distance between lenses, a refractive index, and an Abbe number) are illustrated in Table 1 below.

TABLE 1

| Surface | | Radius of | Thickness/ | Refractive | Abbe |
|---|---|---|---|---|---|
| No. | Element | Curvature | Distance | Index | Number |
| S1 | First | Infinity | 1.000 | 1.546 | 56.0 |
| S2 | Lens | −30.000 | 0.200 | | |
| S3 | Second | 5.993 | 2.018 | 1.546 | 56.0 |
| S4 | Lens | −35.824 | 0.100 | | |
| S5 | Third | −73.804 | 1.205 | 1.646 | 23.5 |
| S6 | Lens | 4.915 | 1.725 | | |
| S7 | Fourth | 5.437 | 1.797 | 1.668 | 20.4 |
| S8 | Lens | −24.156 | 0.120 | | |
| S9 | Fifth | 86.705 | 0.509 | 1.646 | 23.5 |
| S10 | Lens | 5.097 | 1.560 | | |
| S11 | Filter | Infinity | 0.110 | 1.519 | 64.2 |
| S12 | | Infinity | 8.594 | | |
| S13 | Imaging | Infinity | | | |
| | Plane | | | | |

In the first embodiment of the present disclosure, the first lens 110 has a positive refractive power, an object-side surface of the first lens 110 is flat in at least a paraxial region thereof, and an image-side surface of the first lens 110 is convex in a paraxial region thereof. An entire object-side surface of the first lens 110 may be flat.

The second lens 120 has a positive refractive power, and an object-side surface and an image-side surface of the second lens 120 are convex in respective paraxial regions thereof.

The third lens 130 has a negative refractive power, and an object-side surface and an image-side surface of the third lens 130 are concave in respective paraxial regions thereof.

The fourth lens 140 has a positive refractive power, and an object-side surface and an image-side surface of the fourth lens 140 are convex in respective paraxial regions thereof.

The fifth lens 150 has a negative refractive power, an object-side surface of the fifth lens 150 is convex in a paraxial region thereof, and an image-side surface of the fifth lens 150 is concave in a paraxial region thereof.

Each surface of each of the first lens 110 to the fifth lens 150 has aspherical surface coefficients as illustrated in Table 2 below. For example, the object-side surface of the first lens 110 is flat, so all of the aspherical surface coefficients thereof are zero, and the image-side surface of the first lens 110 is aspherical. The object-side surface and the image-side surface of each of the second lens 120 to the fifth lens 150 are aspherical.

TABLE 2

| Surface | | | | | |
|---|---|---|---|---|---|
| No. | S1 | S2 | S3 | S4 | S5 |
| K | 0.000E+00 | 0.000E+00 | −4.585E−01 | −7.297E+00 | 9.528E+01 |
| A | 0.000E+00 | 3.971E−05 | 1.620E−04 | 1.068E−04 | −1.920E−04 |
| B | 0.000E+00 | −6.212E−05 | −1.330E−05 | 1.718E−08 | 1.189E−05 |
| C | 0.000E+00 | 4.263E−05 | 9.302E−06 | 2.833E−07 | 1.858E−07 |
| D | 0.000E+00 | −1.472E−05 | −2.576E−06 | 2.725E−08 | 1.157E−08 |
| E | 0.000E+00 | 2.403E−06 | 4.466E−07 | 1.352E−09 | 1.438E−09 |
| F | 0.000E+00 | −9.411E−08 | −4.890E−08 | 3.475E−11 | 1.710E−10 |
| G | 0.000E+00 | −2.042E−08 | 3.278E−09 | −7.261E−12 | 1.861E−11 |
| H | 0.000E+00 | 2.540E−09 | −1.221E−10 | −8.811E−13 | 1.013E−12 |
| J | 0.000E+00 | −8.500E−11 | 1.904E−12 | 2.413E−13 | −8.833E−14 |

| Surface | | | | | |
|---|---|---|---|---|---|
| No. | S6 | S7 | S8 | S9 | S10 |
| K | 1.503E−01 | 3.726E−01 | −6.226E+01 | −1.443E−01 | 4.296E−01 |
| A | −5.412E−04 | −4.015E−04 | 8.037E−06 | 3.122E−07 | −5.989E−04 |
| B | −3.370E−06 | 1.391E−05 | 6.787E−05 | 2.720E−07 | 1.425E−05 |
| C | −5.584E−07 | −3.539E−07 | −1.680E−06 | −1.250E−07 | −3.139E−06 |
| D | 3.773E−08 | −9.318E−08 | −4.598E−07 | −3.366E−08 | −5.645E−07 |
| E | 4.988E−09 | −7.130E−09 | 1.579E−08 | −6.192E−09 | −1.566E−07 |
| F | 2.957E−10 | −3.724E−10 | 1.192E−08 | −1.130E−09 | −3.620E−08 |
| G | −3.664E−11 | 8.472E−11 | −1.597E−09 | −1.676E−10 | 3.995E−09 |
| H | −1.148E−11 | 2.013E−11 | 1.362E−10 | −3.759E−11 | 1.353E−09 |
| J | −1.192E−12 | 2.932E−12 | −1.409E−11 | −9.130E−12 | 3.312E−10 |

The optical imaging system 100 according to the first embodiment of the present disclosure may have aberration characteristics as illustrated in FIG. 2.

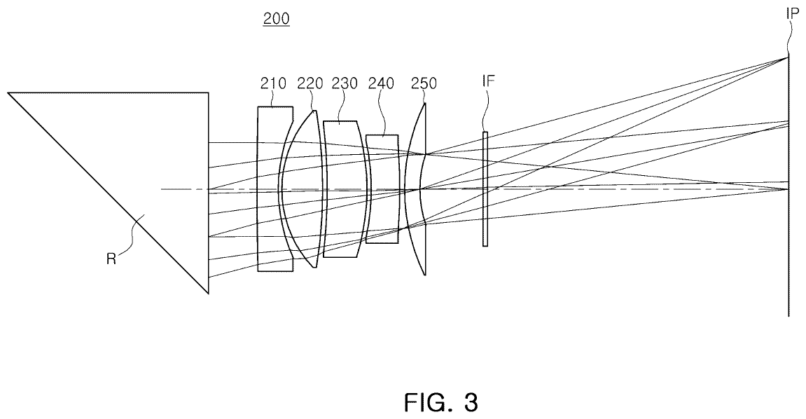

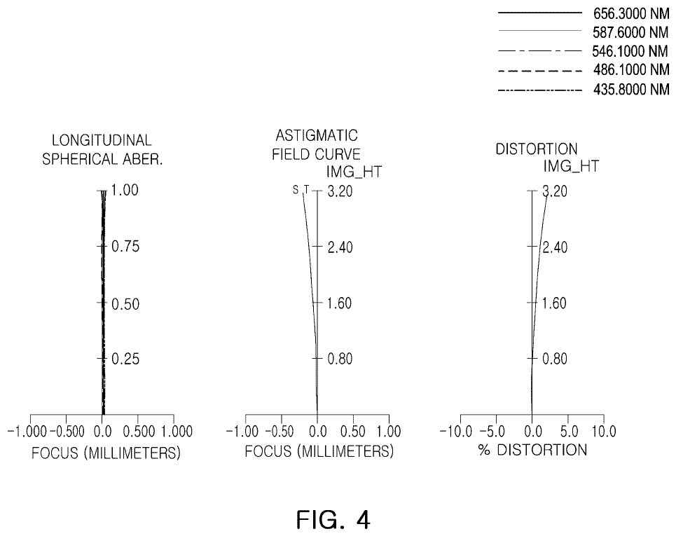

FIG. 3 is a configuration diagram of an optical imaging system according to a second embodiment of the present disclosure, and FIG. 4 is a diagram illustrating aberration characteristics of the optical imaging system illustrated in FIG. 3.

Referring to FIG. 3, an optical imaging system 200 according to the second embodiment of the present disclosure includes a first lens 210, a second lens 220, a third lens 230, a fourth lens 240, and a fifth lens 250 sequentially disposed along an optical axis of the optical imaging system 200 from an object side of the first lens 210 toward an imaging plane IP. The optical imaging system 200 further includes a reflective member R disposed in front of the first lens 210.

In addition, the optical imaging system 200 may further include a filter IF disposed between the fifth lens 250 and the imaging plane IP, and an image sensor (not shown).

The optical imaging system 200 according to the second embodiment of the present disclosure may form a focus on the imaging plane IP. The imaging plane IP may refer to a surface on which a focus is formed by the optical imaging system 200. For example, the imaging plane IP may refer to one surface of an image sensor (not shown) on which light is received.

In the second embodiment of the present disclosure, the reflective member R may be a prism, but may also be provided as a mirror.

Lens characteristics of each lens (radiuses of curvature, a thickness of a lens or a distance between lenses, a refractive index, and an Abbe number) are illustrated in Table 3 below.

TABLE 3

| Surface | | Radius of | Thickness/ | Refractive | Abbe |
|---|---|---|---|---|---|
| No. | Element | Curvature | Distance | Index | Number |
| S1 | First | Infinity | 0.500 | 1.546 | 56.0 |
| S2 | Lens | 4.000 | 0.100 | | |
| S3 | Second | 2.570 | 1.000 | 1.546 | 56.0 |
| S4 | Lens | −9.893 | 0.100 | | |
| S5 | Third | −19.066 | 1.000 | 1.646 | 23.5 |
| S6 | Lens | −5.626 | 0.100 | | |
| S7 | Fourth | −5.819 | 0.705 | 1.668 | 20.4 |
| S8 | Lens | −21.050 | 0.100 | | |
| S9 | Fifth | 4.518 | 0.400 | 1.646 | 23.5 |
| S10 | Lens | 3.002 | 1.560 | | |
| S11 | Filter | Infinity | 0.110 | 1.519 | 64.2 |
| S12 | | Infinity | 7.488 | | |
| S13 | Imaging | Infinity | | | |
| | Plane | | | | |

In the second embodiment of the present disclosure, the first lens 210 has a negative refractive power, an object-side surface of the first lens 210 is flat in at least a paraxial region thereof, and an image-side surface of the first lens 210 is concave in a paraxial region thereof. An entire object-side surface of the first lens 210 may be flat.

The second lens 220 has a positive refractive power, and an object-side surface and an image-side surface of the second lens 220 are convex in respective paraxial regions thereof.

The third lens 230 has a positive refractive power, an object-side surface of the third lens 230 is concave in a paraxial region thereof, and an image-side surface of the third lens 230 is convex in a paraxial region thereof.

The fourth lens 240 has a negative refractive power, an object-side surface of the fourth lens 240 is concave in a paraxial region thereof, and an image-side surface of the fourth lens 240 is convex in a paraxial region thereof.

The fifth lens 250 has a negative refractive power, an object-side surface of the fifth lens 250 is convex in a paraxial region thereof, an image-side surface of the fifth lens 250 is concave in a paraxial region thereof.

Each surface of each of the first lens 210 to the fifth lens 250 has aspherical surface coefficients as illustrated in Table 4 below. For example, the object-side surface of the first lens 210 is flat, so all of the aspherical surface coefficients thereof are zero, and the image-side surface of the first lens 210 is aspherical. The object-side surface and the image-side surface of each of the second lens 220 to the fifth lens 250 are aspherical.

TABLE 4

| Surface | | | | | |
|---|---|---|---|---|---|
| No. | S1 | S2 | S3 | S4 | S5 |
| K | 0.000E+00 | 0.000E+00 | −4.585E−01 | −7.297E+00 | 9.528E+01 |
| A | 0.000E+00 | 2.067E−04 | 1.620E−04 | 1.068E−04 | −1.920E−04 |
| B | 0.000E+00 | 4.584E−04 | −1.330E−05 | 1.718E−08 | 1.189E−05 |
| C | 0.000E+00 | −5.118E−04 | 9.302E−06 | 2.833E−07 | 1.858E−07 |
| D | 0.000E+00 | 2.341E−04 | −2.576E−06 | 2.725E−08 | 1.157E−08 |
| E | 0.000E+00 | −7.244E−06 | 4.466E−07 | 1.352E−09 | 1.438E−09 |
| F | 0.000E+00 | −3.147E−05 | −4.890E−08 | 3.475E−11 | 1.710E−10 |
| G | 0.000E+00 | 7.981E−07 | 3.278E−09 | −7.261E−12 | 1.861E−11 |
| H | 0.000E+00 | 3.778E−06 | −1.221E−10 | −8.811E−13 | 1.013E−12 |
| J | 0.000E+00 | −6.496E−07 | 1.904E−12 | 2.413E−13 | −8.833E−14 |

| Surface | | | | | |
|---|---|---|---|---|---|
| No. | S6 | S7 | S8 | S9 | S10 |
| K | 1.503E−01 | 3.726E−01 | −6.226E+01 | −1.443E−01 | 4.296E−01 |
| A | −5.412E−04 | −4.015E−04 | 8.037E−06 | 3.122E−07 | −5.989E−04 |
| B | −3.370E−06 | 1.391E−05 | 6.787E−05 | 2.720E−07 | 1.425E−05 |
| C | −5.584E−07 | −3.539E−07 | −1.680E−06 | −1.250E−07 | −3.139E−06 |
| D | 3.773E−08 | −9.318E−08 | −4.598E−07 | −3.366E−08 | −5.645E−07 |
| E | 4.988E−09 | −7.130E−09 | 1.579E−08 | −6.192E−09 | −1.566E−07 |
| F | 2.957E−10 | −3.724E−10 | 1.192E−08 | −1.130E−09 | −3.620E−08 |
| G | −3.664E−11 | 8.472E−11 | −1.597E−09 | −1.676E−10 | 3.995E−09 |
| H | −1.148E−11 | 2.013E−11 | 1.362E−10 | −3.759E−11 | 1.353E−09 |
| J | −1.192E−12 | 2.932E−12 | −1.409E−11 | −9.130E−12 | 3.312E−10 |

The optical imaging system 200 according to the second embodiment of the present disclosure may have aberration characteristics as illustrated in FIG. 4.

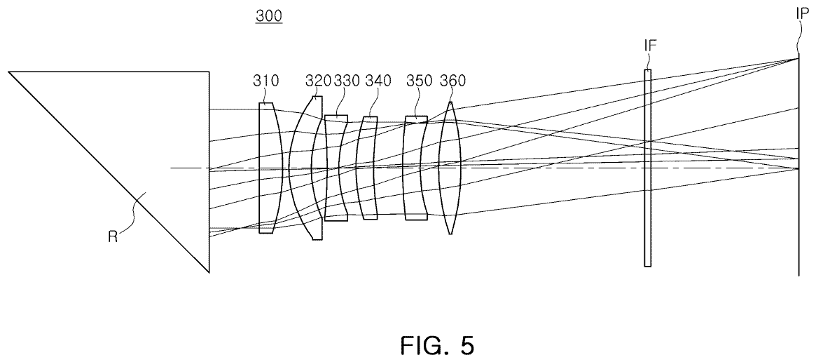

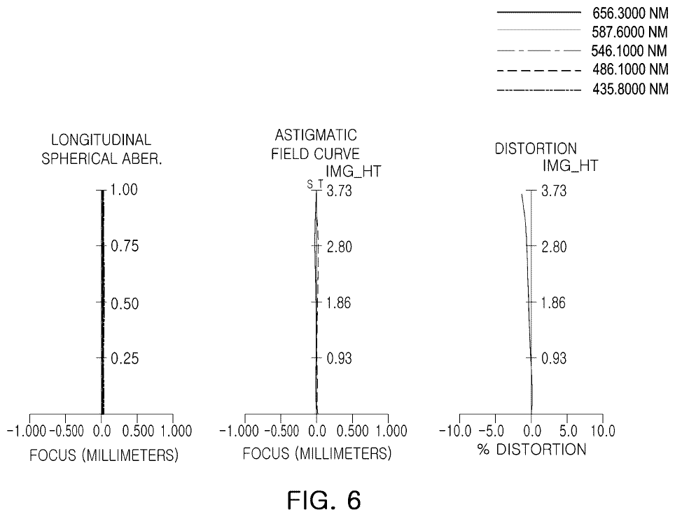

FIG. 5 is a configuration diagram of an optical imaging system according to a third embodiment of the present disclosure, and FIG. 6 is a diagram illustrating aberration characteristics of the optical imaging system illustrated in FIG. 5.

Referring to FIG. 5, an optical imaging system 300 according to the third embodiment of the present disclosure includes a first lens 310, a second lens 320, a third lens 330, a fourth lens 340, a fifth lens 350, and a sixth lens 360 sequentially disposed along an optical axis of the optical imaging system 300 from an object side of the first lens 310 toward an imaging plane IP. The optical imaging system 300 further includes a reflective member R disposed in front of the first lens 310.

In addition, the optical imaging system 300 may further include a filter IF disposed between the sixth lens 360 and the imaging plane IP, and an image sensor (not shown).

The optical imaging system 300 according to the third embodiment of the present disclosure may form a focus on the imaging plane IP. The imaging plane IP may refer to a surface on which a focus is formed by the optical imaging system 300. For example, the imaging plane IP may refer to one surface of an image sensor (not shown) on which light is received.

In the third embodiment of the present disclosure, the reflective member R may be a prism, but may also be provided as a mirror.

Lens characteristics of each lens (radiuses of curvature, a thickness of a lens or a distance between lenses, a refractive index, and an Abbe number) are illustrated in Table 5 below.

TABLE 5

| Surface | | Radius of | Thickness/ | Refractive | Abbe |
|---|---|---|---|---|---|
| No. | Element | Curvature | Distance | Index | Number |
| S1 | First | Infinity | 0.800 | 1.537 | 55.7 |
| S2 | Lens | −6.000 | 0.200 | | |
| S3 | Second | 3.583 | 0.800 | 1.679 | 19.2 |
| S4 | Lens | 3.848 | 0.542 | | |
| S5 | Third | −14.729 | 0.400 | 1.646 | 23.5 |
| S6 | Lens | 4.155 | 0.601 | | |
| S7 | Fourth | 5.725 | 0.600 | 1.537 | 55.7 |
| S8 | Lens | 8.455 | 1.000 | | |
| S9 | Fifth | 13.419 | 0.600 | 1.537 | 55.7 |
| S10 | Lens | 4.652 | 0.615 | | |
| S11 | Sixth | 4.943 | 0.800 | 1.537 | 55.7 |
| S12 | Lens | −10.411 | 6.358 | | |
| S13 | Filter | Infinity | 0.210 | 1.519 | 64.2 |
| S14 | | Infinity | 5.095 | | |
| S15 | Imaging | Infinity | | | |
| | Plane | | | | |

The first lens 310 has a positive refractive power, an object-side surface of the first lens 310 is flat in at least a paraxial region thereof, and an image-side surface of the first lens 310 is convex in a paraxial region thereof. An entire object-side surface of the first lens 310 may be flat.

The second lens 320 has a positive refractive power, an object-side surface of the second lens 320 is convex in a paraxial region thereof, and an image-side surface of the second lens 320 is concave in a paraxial region thereof.

The third lens 330 has a negative refractive power, and an object-side surface and an image-side surface of the third lens 330 are concave in respective paraxial regions thereof.

The fourth lens 340 has a positive refractive power, an object-side surface of the fourth lens 340 is convex in a paraxial region thereof, and an image-side surface of the fourth lens 340 is concave in a paraxial region thereof.

The fifth lens 350 has a negative refractive power, an object-side surface of the fifth lens 350 is convex in a paraxial region thereof, and an image-side surface of the fifth lens 350 is concave in a paraxial region thereof.

The sixth lens 360 has a positive refractive power, and an object-side surface and an image-side surface of the sixth lens 360 are convex in respective paraxial regions thereof.

Each surface of each of the first lens 310 to the sixth lens 360 has aspherical surface coefficients as illustrated in Table 6 below. For example, the object-side surface of the first lens 310 is flat, so all of the aspherical surface coefficients thereof are zero, and the image-side surface of the first lens 310 is aspherical. The object-side surface and the image-side surface of each of the second lens 320 to the sixth lens 360 are aspherical.

TABLE 6

| Surface | | | | | | |
|---|---|---|---|---|---|---|
| No. | S1 | S2 | S3 | S4 | S5 | S6 |
| K | 0.000E+00 | 0.000E+00 | −6.395E−01 | −2.342E+00 | −9.900E+01 | 7.210E−02 |
| A | 0.000E+00 | 4.499E−03 | 3.629E−04 | 1.374E−04 | −1.461E−03 | −3.250E−03 |
| B | 0.000E+00 | −3.764E−04 | 9.937E−05 | 5.588E−05 | 1.188E−04 | 2.888E−05 |
| C | 0.000E+00 | 7.636E−05 | 2.310E−05 | 3.201E−05 | −2.252E−06 | −1.024E−05 |
| D | 0.000E+00 | −1.639E−05 | 2.197E−06 | 1.092E−05 | −1.231E−07 | 1.806E−06 |
| E | 0.000E+00 | 1.613E−06 | 9.779E−08 | 1.605E−06 | −3.344E−08 | −1.223E−07 |
| F | 0.000E+00 | 1.074E−07 | 6.453E−08 | −6.999E−08 | −2.450E−09 | −2.607E−08 |
| G | 0.000E+00 | −7.533E−09 | 1.599E−08 | −1.406E−07 | −8.714E−11 | −1.273E−09 |
| H | 0.000E+00 | −6.514E−09 | 1.465E−10 | −3.911E−08 | 1.641E−12 | −1.639E−10 |
| J | 0.000E+00 | 5.738E−10 | −2.768E−09 | 4.999E−09 | 3.112E−12 | −2.672E−11 |

| Surface | | | | | | |
|---|---|---|---|---|---|---|
| No. | S7 | S8 | S9 | S10 | S11 | S12 |
| K | 6.836E−02 | −4.010E+00 | 3.550E+00 | −9.767E−02 | −6.280E−01 | −2.194E+01 |
| A | −2.746E−03 | −3.019E−03 | −2.619E−03 | −5.988E−03 | −5.320E−03 | −3.656E−03 |
| B | 1.948E−04 | 3.029E−04 | −5.074E−05 | 3.311E−04 | −1.291E−04 | −1.637E−04 |
| C | −6.535E−06 | −2.264E−05 | 3.540E−05 | 1.013E−04 | 3.872E−05 | −3.742E−05 |
| D | −5.637E−07 | −3.128E−07 | −7.210E−06 | 1.516E−05 | 6.581E−06 | 4.971E−06 |
| E | 2.064E−07 | −2.172E−07 | −4.210E−07 | −8.412E−06 | −6.050E−07 | 2.015E−06 |
| F | 2.012E−11 | −1.543E−07 | −2.179E−07 | −5.714E−08 | −3.642E−07 | −6.804E−07 |
| G | −2.931E−09 | −2.728E−08 | −3.319E−08 | 8.359E−08 | −6.154E−08 | 6.050E−08 |
| H | −2.370E−09 | 5.475E−10 | 1.409E−09 | 2.059E−08 | 2.667E−08 | −2.322E−08 |
| J | 3.760E−11 | 2.752E−10 | 9.437E−10 | −1.891E−18 | −1.042E−09 | 4.291E−09 |

The optical imaging system 300 according to the third embodiment of the present disclosure may have aberration characteristics as illustrated in FIG. 6.

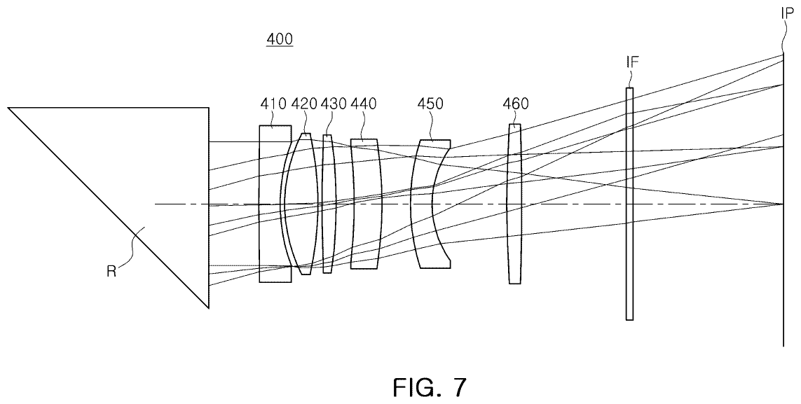

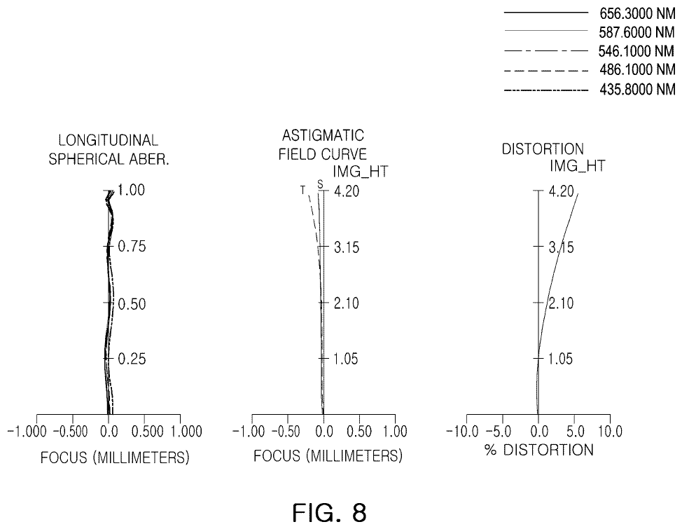

FIG. 7 is a configuration diagram of an optical imaging system according to a fourth embodiment of the present disclosure, and FIG. 8 is a diagram illustrating aberration characteristics of the optical imaging system illustrated in FIG. 7.

Referring to FIG. 7, an optical imaging system 400 according to the fourth embodiment of the present disclosure includes a first lens 410, a second lens 420, a third lens 430, a fourth lens 440, a fifth lens 450, and a sixth lens 460 sequentially disposed in ascending numerical order along an optical axis of the optical imaging system 400 from an object side of the first lens 410 toward an imaging plane IP. The optical imaging system 400 further includes a reflective member R disposed in front of the first lens 410.

In addition, the optical imaging system 400 may further include a filter IF disposed between the sixth lens 460 and the imaging plane IP, and an image sensor (not shown).

The optical imaging system 400 according to the fourth embodiment of the present disclosure may form a focus on the imaging plane IP. The imaging plane IP may refer to a surface on which a focus is formed by the optical imaging system 400. For example, the imaging plane IP may refer to one surface of an image sensor (not shown) on which light is received.

In the fourth embodiment of the present disclosure, the reflective member R may be a prism, but may also be provided as a mirror.

Lens characteristics of each lens (radiuses of curvature, a thickness of a lens or a distance between lenses, a refractive index, and an Abbe number) are illustrated in Table 7 below.

TABLE 7

| Surface | | Radius of | Thickness/ | Refractive | Abbe |
|---|---|---|---|---|---|
| No. | Element | Curvature | Distance | Index | Number |
| S1 | First | Infinity | 0.600 | 1.621 | 26.0 |
| S2 | Lens | 5.000 | 0.100 | | |
| S3 | Second | 3.847 | 1.000 | 1.537 | 55.7 |
| S4 | Lens | −7.948 | 0.100 | | |
| S5 | Third | 26.677 | 0.400 | 1.621 | 26.0 |
| S6 | Lens | −24.049 | 0.524 | | |
| S7 | Fourth | −18.108 | 0.800 | 1.537 | 55.7 |
| S8 | Lens | −13.864 | 0.827 | | |
| S9 | Fifth | 6.154 | 0.600 | 1.537 | 55.7 |
| S10 | Lens | 2.448 | 2.168 | | |
| S11 | Sixth | 21.993 | 0.400 | 1.537 | 55.7 |
| S12 | Lens | 44.190 | 3.021 | | |
| S13 | Filter | Infinity | 0.210 | 1.519 | 64.2 |
| S14 | | Infinity | 4.320 | | |
| S15 | Imaging | Infinity | | | |
| | Plane | | | | |

The first lens 410 has a negative refractive power, an object-side surface of the first lens 410 is flat in at least a paraxial region thereof, and an image-side surface of the first lens 410 is concave in a paraxial region thereof. An entire object-side surface of the first lens 410 may be flat.

The second lens 420 has a positive refractive power, and an object-side surface and an image-side surface of the second lens 420 are convex in respective paraxial regions thereof.

The third lens 430 has a positive refractive power, and an object-side surface and an image-side surface of the third lens 430 are convex in respective paraxial regions thereof.

The fourth lens 440 has a positive refractive power, an object-side surface of the fourth lens 440 is concave in a paraxial region thereof, and an image-side surface of the fourth lens 440 is convex in a paraxial region thereof.

The fifth lens 450 has a negative refractive power, an object-side surface of the fifth lens 450 is convex in a paraxial region thereof, and an image-side surface of the fifth lens 450 is concave in a paraxial region thereof.

The sixth lens 460 has a positive refractive power, an object-side surface of the sixth lens 460 is convex in a paraxial region thereof, and an image-side surface of the sixth lens 460 is concave in a paraxial region thereof.

Each surface of each of the first lens 410 to the sixth lens 460 has aspherical surface coefficients as illustrated in Table 8 below. For example, the object-side surface of the first lens 410 is flat, so all of the aspherical surface coefficients thereof are zero, and the image-side surface of the first lens 410 is aspherical. The object-side surface and the image-side surface of each of the second lens 420 to the sixth lens 460 are aspherical.

TABLE 8

| Surface | | | | | | |
|---|---|---|---|---|---|---|
| No. | S1 | S2 | S3 | S4 | S5 | S6 |
| K | 0.000E+00 | 0.000E+00 | −6.863E−01 | −2.342E+00 | −9.900E+01 | 7.210E−02 |
| A | 0.000E+00 | 5.536E−04 | 2.635E−04 | 7.535E−04 | −1.461E−03 | −3.250E−03 |
| B | 0.000E+00 | 2.301E−03 | −5.561E−06 | −1.805E−05 | 1.188E−04 | 2.888E−05 |
| C | 0.000E+00 | −1.912E−03 | −4.565E−07 | −1.468E−06 | −2.252E−06 | −1.024E−05 |
| D | 0.000E+00 | 7.482E−04 | −3.257E−08 | −1.568E−07 | −1.231E−07 | 1.806E−06 |
| E | 0.000E+00 | −7.295E−05 | −8.916E−09 | −1.622E−08 | −3.344E−08 | −1.223E−07 |
| F | 0.000E+00 | −4.855E−05 | 2.145E−10 | −2.624E−09 | −2.450E−09 | −2.607E−08 |
| G | 0.000E+00 | 2.604E−05 | −3.916E−11 | −1.945E−10 | −8.714E−11 | −1.273E−09 |
| H | 0.000E+00 | −6.433E−06 | −9.543E−12 | −1.208E−11 | 1.641E−12 | −1.639E−10 |
| J | 0.000E+00 | 6.636E−07 | −8.725E−13 | 2.988E−12 | 3.112E−12 | −2.672E−11 |

| Surface | | | | | | |
|---|---|---|---|---|---|---|
| No. | S7 | S8 | S9 | S10 | S11 | S12 |
| K | 6.836E−02 | −4.010E+00 | 3.550E+00 | −9.767E−02 | −6.280E−01 | −2.194E+01 |
| A | −2.746E−03 | −3.019E−03 | −2.619E−03 | −5.988E−03 | −5.310E−03 | −3.829E−03 |
| B | 1.948E−04 | 3.029E−04 | −5.074E−05 | 3.311E−04 | 1.740E−04 | −9.681E−05 |
| C | −6.535E−06 | −2.264E−05 | 3.540E−05 | 1.013E−04 | 6.166E−05 | 2.340E−05 |
| D | −5.637E−07 | −3.128E−07 | −7.210E−06 | 1.516E−05 | 8.240E−06 | 1.219E−05 |
| E | 2.064E−07 | −2.172E−07 | −4.210E−07 | −8.412E−06 | 5.854E−07 | 1.351E−06 |
| F | 2.012E−11 | −1.543E−07 | −2.179E−07 | −5.714E−08 | −6.103E−08 | −8.659E−07 |
| G | −2.931E−09 | −2.728E−08 | −3.319E−08 | 8.359E−08 | −6.390E−08 | 9.654E−08 |
| H | −2.370E−09 | 5.475E−10 | 1.409E−09 | 2.059E−08 | 8.705E−09 | 4.279E−11 |
| J | 3.760E−11 | 2.752E−10 | 9.437E−10 | −1.891E−18 | 3.640E−11 | 4.719E−11 |

The optical imaging system 400 according to the fourth embodiment of the present disclosure may have aberration characteristics as illustrated in FIG. 8.

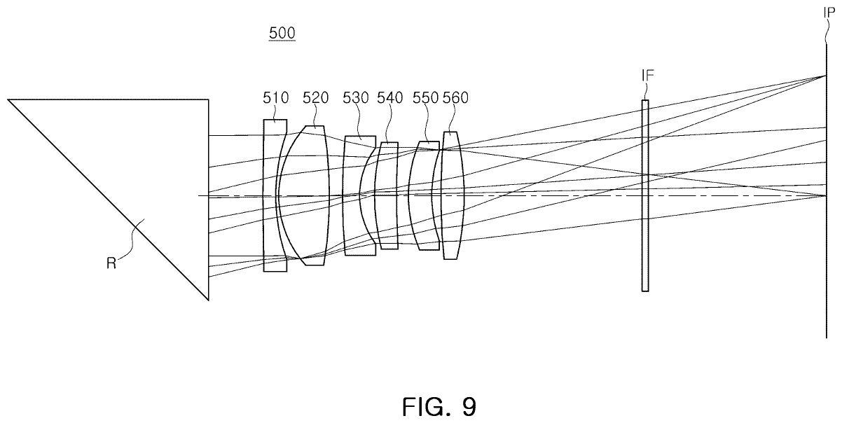

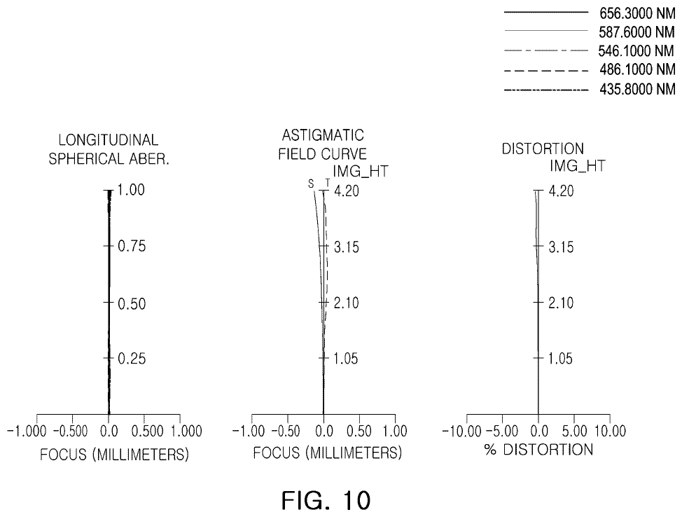

FIG. 9 is a configuration diagram of an optical imaging system according to a fifth embodiment of the present disclosure, and FIG. 10 is a diagram illustrating aberration characteristics of the optical imaging system illustrated in FIG. 9.

Referring to FIG. 9, an optical imaging system 500 according to the fifth embodiment of the present disclosure includes a first lens 510, a second lens 520, a third lens 530, a fourth lens 540, a fifth lens 550, and a sixth lens 560 sequentially disposed in ascending numerical order along an optical axis of the optical imaging system 500 from an object side of the first lens 510 toward an imaging plane IP. The optical imaging system 500 further includes a reflective member R disposed in front of the first lens 510.

In addition, the optical imaging system 500 may further include a filter IF disposed between the sixth lens 560 and the imaging plane IP, and an image sensor (not shown).

The optical imaging system 500 according to the fifth embodiment of the present disclosure may form a focus on the imaging plane IP. The imaging plane IP may refer to a surface on which a focus is formed by the optical imaging system 500. For example, the imaging plane IP may refer to one surface of an image sensor (not shown) on which light is received.

In the fifth embodiment of the present disclosure, the reflective member R may be a prism, but may also be provided as a mirror.

Lens characteristics of each lens (radiuses of curvature, a thickness of a lens or a distance between lenses, a refractive index, and an Abbe number) are illustrated in Table 9 below.

TABLE 9

| Surface | | Radius of | Thickness/ | Refractive | Abbe |
|---|---|---|---|---|---|
| No. | Element | Curvature | Distance | Index | Number |
| S1 | First | Infinity | 0.400 | 1.537 | 55.7 |
| S2 | Lens | 6.000 | 0.100 | | |
| S3 | Second | 3.141 | 1.800 | 1.537 | 55.7 |
| S4 | Lens | −15.792 | 0.514 | | |
| S5 | Third | 19.259 | 0.600 | 1.621 | 26.0 |
| S6 | Lens | 2.659 | 0.517 | | |
| S7 | Fourth | 6.838 | 0.800 | 1.679 | 19.2 |
| S8 | Lens | 24.170 | 0.435 | | |
| S9 | Fifth | 5.372 | 0.800 | 1.621 | 26.0 |
| S10 | Lens | 4.300 | 0.339 | | |
| S11 | Sixth | 17.297 | 0.800 | 1.547 | 56.1 |
| S12 | Lens | −11.295 | 6.358 | | |
| S13 | Filter | Infinity | 0.210 | 1.519 | 64.2 |
| S14 | | Infinity | 6.331 | | |
| S15 | Imaging | Infinity | | | |
| | Plane | | | | |

The first lens 510 has a negative refractive power, an object-side surface of the first lens 510 is flat in at least a paraxial region thereof, and an image-side surface of the first lens 510 is concave in a paraxial region thereof. An entire object-side surface of the first lens 510 may be flat.

The second lens 520 has a positive refractive power, and an object-side surface and an image-side surface of the second lens 520 are convex in respective paraxial regions thereof.

The third lens 530 has a negative refractive power, an object-side surface of the third lens 530 is convex in a paraxial region thereof, and an image-side surface of the third lens 530 is concave in a paraxial region thereof.

The fourth lens 540 has a positive refractive power, an object-side surface of the fourth lens 540 is convex in a paraxial region thereof, and an image-side surface of the fourth lens 540 is concave in a paraxial region thereof.

The fifth lens 550 has a negative refractive power, an object-side surface of the fifth lens 550 is convex in a paraxial region thereof, and an image-side surface of the fifth lens 550 is concave in a paraxial region thereof.

The sixth lens 560 has a positive refractive power, and an object-side surface and an image-side surface of the sixth lens 560 are convex in respective paraxial regions thereof.

Each surface of each of the first lens 510 to the sixth lens 560 has aspherical surface coefficients as illustrated in Table 10 below. For example, the object-side surface of the first lens 510 is flat, so all of the aspherical surface coefficients thereof are zero, and the image-side surface of the first lens 510 is aspherical. The object-side surface and the image-side surface of each of the second lens 520 to the sixth lens 560 are aspherical.

TABLE 10

| Surface | | | | | | |
|---|---|---|---|---|---|---|
| No. | S1 | S2 | S3 | S4 | S5 | S6 |
| K | 0.000E+00 | 0.000E+00 | −6.863E−01 | −2.342E+00 | −9.900E+01 | 7.210E−02 |
| A | 0.000E+00 | −4.742E−04 | 2.635E−04 | 7.535E−04 | −1.461E−03 | −3.250E−03 |
| B | 0.000E+00 | 6.914E−05 | −5.561E−06 | −1.805E−05 | 1.188E−04 | 2.888E−05 |
| C | 0.000E+00 | −2.374E−05 | −4.565E−07 | −1.468E−06 | −2.252E−06 | −1.024E−05 |
| D | 0.000E+00 | 2.222E−06 | −3.257E−08 | −1.568E−07 | −1.231E−07 | 1.806E−06 |
| E | 0.000E+00 | 9.024E−08 | −8.916E−09 | −1.622E−08 | −3.344E−08 | −1.223E−07 |
| F | 0.000E+00 | −3.280E−08 | 2.145E−10 | −2.624E−09 | −2.450E−09 | −2.607E−08 |
| G | 0.000E+00 | −1.067E−09 | −3.916E−11 | −1.945E−10 | −8.714E−11 | −1.273E−09 |
| H | 0.000E+00 | 9.547E−10 | −9.543E−12 | −1.208E−11 | 1.641E−12 | −1.639E−10 |
| J | 0.000E+00 | −6.097E−11 | −8.725E−13 | 2.988E−12 | 3.112E−12 | −2.672E−11 |

| Surface | | | | | | |
|---|---|---|---|---|---|---|
| No. | S7 | S8 | S9 | S10 | S11 | S12 |
| K | 6.836E−02 | −4.010E+00 | 3.550E+00 | −9.767E−02 | −6.280E−01 | −2.194E+01 |
| A | −2.746E−03 | −3.019E−03 | −2.619E−03 | −5.988E−03 | −5.310E−03 | −3.829E−03 |
| B | 1.948E−04 | 3.029E−04 | −5.074E−05 | 3.311E−04 | 1.740E−04 | −9.681E−05 |
| C | −6.535E−06 | −2.264E−05 | 3.540E−05 | 1.013E−04 | 6.166E−05 | 2.340E−05 |
| D | −5.637E−07 | −3.128E−07 | −7.210E−06 | 1.516E−05 | 8.240E−06 | 1.219E−05 |
| E | 2.064E−07 | −2.172E−07 | −4.210E−07 | −8.412E−06 | 5.854E−07 | 1.351E−06 |
| F | 2.012E−11 | −1.543E−07 | −2.179E−07 | −5.714E−08 | −6.103E−08 | −8.659E−07 |
| G | −2.931E−09 | −2.728E−08 | −3.319E−08 | 8.359E−08 | −6.390E−08 | 9.654E−08 |
| H | −2.370E−09 | 5.475E−10 | 1.409E−09 | 2.059E−08 | 8.705E−09 | 4.279E−11 |
| J | 3.760E−11 | 2.752E−10 | 9.437E−10 | −1.891E−18 | 3.640E−11 | 4.719E−11 |

The optical imaging system 500 according to the fifth embodiment of the present disclosure may have aberration characteristics as illustrated in FIG. 10.

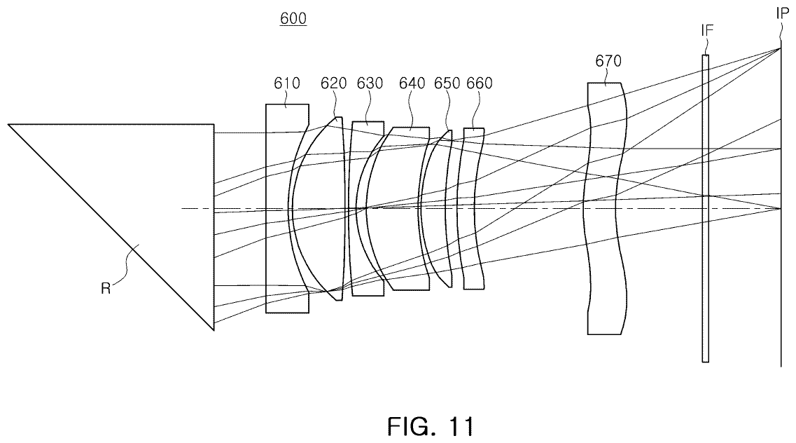

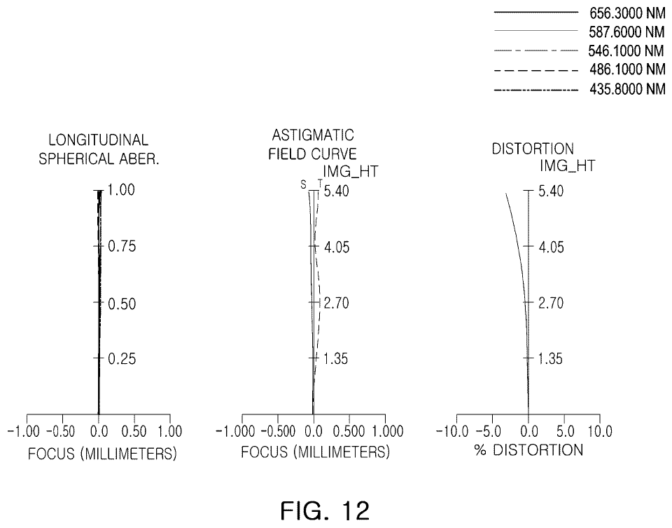

FIG. 11 is a configuration diagram of an optical imaging system according to a sixth embodiment of the present disclosure, and FIG. 12 is a diagram illustrating aberration characteristics of the optical imaging system illustrated in FIG. 11.

Referring to FIG. 11, an optical imaging system 600 according to the sixth embodiment of the present disclosure includes a first lens 610, a second lens 620, a third lens 630, a fourth lens 640, a fifth lens 650, a sixth lens 660, and a seventh lens 670 sequentially disposed in ascending numerical order along an optical axis of the optical imaging system 600 from an object side of the first lens 210 toward an imaging plane IP. The optical imaging system 600 further includes a reflective member R disposed in front of the first lens 610.

In addition, the optical imaging system 600 may further include a filter IF disposed between the seventh lens 670 and the imaging plane IP, and an image sensor (not shown).

The optical imaging system 600 according to the sixth embodiment of the present disclosure may form a focus on the imaging plane IP. The imaging plane IP may refer to a surface on which a focus is formed by the optical imaging system 600. For example, the imaging plane IP may refer to one surface of an image sensor (not show) on which light is received.

In the sixth embodiment of the present disclosure, the reflective member R may be a prism, but may also be provided as a mirror.

Lens characteristics of each lens (radiuses of curvature, a thickness of a lens or a distance between lenses, a refractive index, and an Abbe number) are illustrated in Table 11 below.

TABLE 11

| Surface | | Radius of | Thickness/ | Refractive | Abbe |
|---|---|---|---|---|---|
| No. | Element | Curvature | Distance | Index | Number |
| S1 | First | Infinity | 0.800 | 1.537 | 55.7 |
| S2 | Lens | 6.000 | 0.100 | | |
| S3 | Second | 3.293 | 1.849 | 1.537 | 55.7 |
| S4 | Lens | −39.982 | 0.100 | | |
| S5 | Third | 33.588 | 0.300 | 1.646 | 23.5 |
| S6 | Lens | 3.481 | 0.330 | | |
| S7 | Fourth | 4.423 | 1.800 | 1.679 | 19.2 |
| S8 | Lens | 6.746 | 0.100 | | |
| S9 | Fifth | 4.963 | 0.830 | 1.537 | 55.7 |
| S10 | Lens | 15.526 | 0.409 | | |
| S11 | Sixth | 7.543 | 0.612 | 1.646 | 23.5 |
| S12 | Lens | 8.208 | 3.750 | | |
| S13 | Seventh | 5.752 | 1.096 | 1.537 | 55.7 |
| S14 | Lens | 4.652 | 3.000 | | |
| S15 | Filter | Infinity | 0.210 | 1.519 | 64.2 |
| S16 | | Infinity | 2.527 | | |
| Image | Imaging | Infinity | | | |
| | Plane | | | | |

The first lens 610 has a negative refractive power, an object-side surface of the first lens 610 is flat in at least a paraxial region thereof, and an image-side surface of the first lens 610 is concave in a paraxial region thereof. An entire object-side surface of the first lens 610 may be flat.

The second lens 620 has a positive refractive power, and an object-side surface and an image-side surface of the second lens 620 are convex in respective paraxial regions thereof.

The third lens 630 has a negative refractive power, an object-side surface of the third lens 630 is convex in a paraxial region thereof, and an image-side surface of the third lens 630 is concave in a paraxial region thereof.

The fourth lens 640 has a positive refractive power, an object-side surface of the fourth lens 640 is convex in a paraxial region thereof, and an image-side surface of the fourth lens 640 is concave in a paraxial region thereof.

The fifth lens 650 has a positive refractive power, an object-side surface of the fifth lens 650 is convex in a paraxial region thereof, and an image-side surface of the fifth lens 650 is concave in a paraxial region thereof.

The sixth lens 660 has a positive refractive power, an object-side surface of the sixth lens 660 is convex in a paraxial region thereof, and an image-side surface of the sixth lens 660 is concave in a paraxial region thereof.

The seventh lens 670 has a negative refractive power, an object-side surface of the seventh lens 670 is convex in a paraxial region thereof, and an image-side surface of the seventh lens 670 is concave in a paraxial region thereof.

Each surface of the first lens 610 to the seventh lens 670 has aspherical surface coefficients as illustrated in Table 12 below. For example, the object-side surface of the first lens 610 is flat, so all of the aspherical surface coefficients thereof are zero, and the image-side surface of the first lens 610 is aspherical. The object-side surface and the image-side surface of each of the second lens 620 to the seventh lens 670 are aspherical.

TABLE 12

| Surface | | | | | |
|---|---|---|---|---|---|
| No. | S1 | S2 | S3 | S4 | S5 |
| K | 0.000E+00 | 0.000E+00 | −6.726E−01 | −9.900E+01 | 9.750E+01 |
| A | 0.000E+00 | −7.617E−05 | 1.513E−05 | 2.219E−04 | −6.529E−05 |
| B | 0.000E+00 | −8.782E−06 | −1.587E−05 | −7.704E−06 | 1.624E−05 |
| C | 0.000E+00 | 1.744E−06 | −1.072E−06 | −9.821E−07 | −9.023E−07 |
| D | 0.000E+00 | −1.887E−06 | −4.085E−08 | −9.511E−08 | −1.280E−07 |
| E | 0.000E+00 | 6.011E−07 | −1.515E−09 | −4.290E−09 | −1.304E−08 |
| F | 0.000E+00 | −5.461E−08 | −2.880E−11 | −1.958E−10 | −8.611E−10 |
| G | 0.000E+00 | −5.976E−09 | 4.506E−12 | −2.780E−11 | −3.708E−11 |
| H | 0.000E+00 | 1.368E−09 | −9.547E−13 | 1.839E−12 | 3.613E−13 |
| J | 0.000E+00 | −6.352E−11 | 2.540E−14 | 1.625E−13 | 3.213E−13 |

| Surface | | | | | |
|---|---|---|---|---|---|
| No. | S6 | S7 | S8 | S9 | S10 |
| K | 0.000E+00 | 0.000E+00 | −7.552E−02 | 2.650E−01 | −9.264E−01 |
| A | −1.167E−03 | −5.586E−04 | −8.107E−04 | −9.999E−04 | −3.696E−04 |
| B | −5.893E−05 | −4.645E−05 | −2.266E−05 | 8.299E−05 | 7.668E−05 |
| C | 2.701E−07 | −1.829E−08 | −1.919E−06 | 1.375E−05 | 3.288E−05 |
| D | 1.964E−07 | 3.587E−07 | 2.533E−08 | 4.874E−06 | 6.596E−06 |
| E | −1.227E−08 | 2.977E−08 | 1.963E−07 | 5.884E−07 | 4.247E−07 |
| F | −4.205E−09 | 6.521E−09 | 4.578E−08 | 6.671E−08 | 5.117E−08 |
| G | −7.507E−10 | 5.262E−10 | 4.170E−09 | 6.433E−09 | 5.982E−09 |
| H | −5.532E−11 | 2.086E−11 | −1.770E−10 | 2.006E−10 | 4.603E−11 |
| J | 1.169E−11 | −1.705E−11 | −2.157E−10 | −3.297E−10 | −1.190E−10 |

| Surface | | | | |
|---|---|---|---|---|
| No. | S11 | S12 | S13 | S14 |
| K | −2.574E+00 | 1.028E+00 | −8.371E+00 | −5.038E+00 |
| A | −1.904E−03 | −1.389E−03 | −4.040E−03 | −4.669E−03 |
| B | −6.826E−05 | 2.083E−04 | −1.180E−04 | 1.800E−05 |
| C | −3.085E−06 | −3.759E−05 | 1.160E−05 | 7.613E−06 |
| D | −4.140E−06 | −6.793E−06 | 4.839E−07 | 1.334E−08 |
| E | −6.835E−07 | 2.383E−07 | −1.546E−08 | −2.488E−08 |
| F | −3.243E−08 | 6.850E−09 | −3.753E−09 | −9.972E−10 |
| G | 4.134E−09 | −4.105E−09 | 1.393E−14 | 1.955E−10 |
| H | 2.000E−09 | 2.285E−09 | −3.087E−12 | −1.107E−11 |
| J | −1.440E−10 | −1.124E−10 | 8.221E−13 | 2.843E−13 |

The optical imaging system 600 according to the sixth embodiment of the present disclosure may have aberration characteristics as illustrated in FIG. 12.

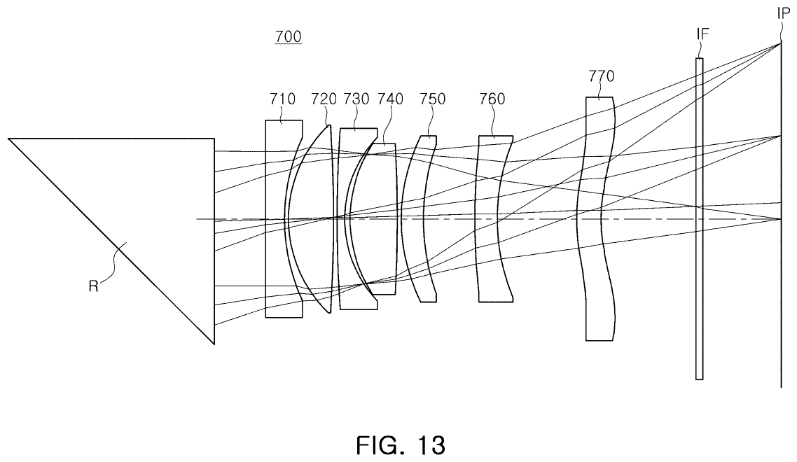

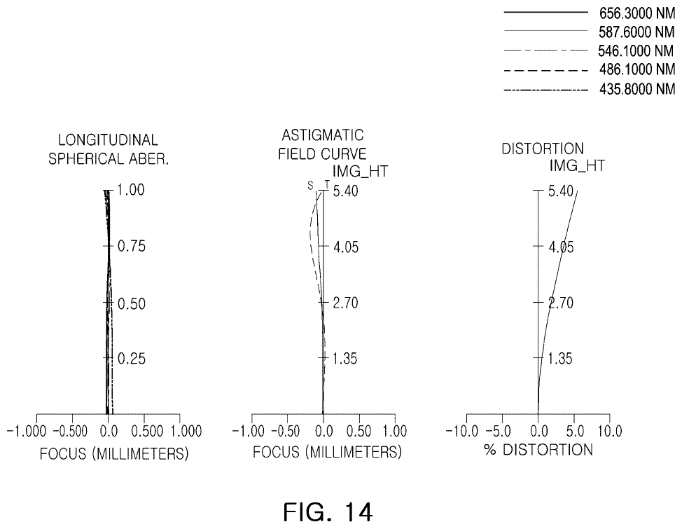

FIG. 13 is a configuration diagram of an optical imaging system according to a seventh embodiment of the present disclosure, and FIG. 14 is a diagram illustrating aberration characteristics of the optical imaging system illustrated in FIG. 13.

Referring to FIG. 13, an optical imaging system 700 according to the seventh embodiment of the present disclosure includes a first lens 710, a second lens 720, a third lens 730, a fourth lens 740, a fifth lens 750, a sixth lens 760, and a seventh lens 770 sequentially disposed in ascending numerical order along an optical axis of the optical imaging system 700 from an object side of the first lens 710 toward an imaging plane IP. The optical imaging system 700 further includes a reflective member R disposed in front of the first lens 710.

In addition, the optical imaging system 700 may further include a filter IF disposed between the seventh lens 770 and the imaging plane IP, and an image sensor (not shown).

The optical imaging system 700 according to the seventh embodiment of the present disclosure may form a focus on the imaging plane IP. The imaging plane IP may refer to a surface on which a focus is formed by the optical imaging system 700. For example, the imaging plane IP may refer to one surface of an image sensor (not shown) on which light is received.

In the seventh embodiment of the present disclosure, the reflective member R may be a prism, but may also be provided as a mirror.

Lens characteristics of each lens (radiuses of curvature, a thickness of a lens or a distance between lenses, a refractive index, and an Abbe (number) are illustrated in Table 13 below.

TABLE 13

| Surface | | Radius of | Thickness/ | Refractive | Abbe |
|---|---|---|---|---|---|
| No. | Element | Curvature | Distance | Index | Number |
| S1 | First | Infinity | 0.600 | 1.646 | 23.5 |
| S2 | Lens | 6.000 | 0.100 | | |
| S3 | Second | 3.393 | 1.433 | 1.537 | 55.7 |
| S4 | Lens | −33.790 | 0.100 | | |
| S5 | Third | 40.987 | 0.260 | 1.646 | 23.5 |
| S6 | Lens | 3.452 | 0.144 | | |
| S7 | Fourth | 4.131 | 1.500 | 1.679 | 19.2 |
| S8 | Lens | −64.040 | 0.100 | | |
| S9 | Fifth | 6.432 | 0.775 | 1.537 | 55.7 |
| S10 | Lens | 9.936 | 1.559 | | |
| S11 | Sixth | 13.559 | 0.703 | 1.646 | 23.5 |
| S12 | Lens | 5.809 | 2.478 | | |
| S13 | Seventh | 4.968 | 0.758 | 1.537 | 55.7 |
| S14 | Lens | 4.182 | 3.000 | | |
| S15 | Filter | Infinity | 0.210 | 1.519 | 64.2 |
| S16 | | Infinity | 2.462 | | |
| Image | Imaging | Infinity | | | |
| | Plane | | | | |

The first lens 710 has a negative refractive power, an object-side surface of the first lens 710 is flat in at least a paraxial region thereof, and an image-side surface of the first lens 710 is concave in a paraxial region thereof. An entire object-side surface of the first lens 710 may be flat.

The second lens 720 has a positive refractive power, and an object-side surface and an image-side surface of the second lens 720 are convex in respective paraxial regions thereof.

The third lens 730 has a negative refractive power, an object-side surface of the third lens 730 is convex in a paraxial region thereof, and an image-side surface of the third lens 730 is concave in a paraxial region thereof.

The fourth lens 740 has a positive refractive power, and an object-side surface and an image-side surface of the fourth lens 740 are convex in respective paraxial regions thereof.

The fifth lens 750 has a positive refractive power, an object-side surface of the fifth lens 750 is convex in a paraxial region thereof, and an image-side surface of the fifth lens 750 is concave in a paraxial region thereof.

The sixth lens 760 has a negative refractive power, an object-side surface of the sixth lens 760 is convex in a paraxial region thereof, and an image-side surface of the sixth lens 760 is concave in a paraxial region thereof.

The seventh lens 770 has a negative refractive power, an object-side surface of the seventh lens 770 is convex in a paraxial region thereof, and an image-side surface of the seventh lens 770 is concave in a paraxial region thereof.

Each surface of each of the first lens 710 to the seventh lens 770 has aspherical surface coefficients as illustrated in Table 14 below. For example, the object-side surface of the first lens 710 is flat, so all of the aspherical surface coefficients thereof are zero, and the image-side surface of the first lens 710 is aspherical. The object-side surface and the image-side surface of each of the second lens 720 to the seventh lens 770 are aspherical.

TABLE 14

| Surface | | | | | |
|---|---|---|---|---|---|
| No. | S1 | S2 | S3 | S4 | S5 |
| K | 0.000E+00 | 0.000E+00 | −6.726E−01 | −9.900E+01 | 9.750E+01 |
| A | 0.000E+00 | 7.578E−05 | 1.513E−05 | 2.219E−04 | −6.529E−05 |
| B | 0.000E+00 | 2.846E−05 | −1.587E−05 | −7.704E−06 | 1.624E−05 |
| C | 0.000E+00 | 6.491E−06 | −1.072E−06 | −9.821E−07 | −9.023E−07 |
| D | 0.000E+00 | −2.017E−06 | −4.085E−08 | −9.511E−08 | −1.280E−07 |
| E | 0.000E+00 | 4.754E−07 | −1.515E−09 | −4.290E−09 | −1.304E−08 |
| F | 0.000E+00 | −6.814E−08 | −2.880E−11 | −1.958E−10 | −8.611E−10 |
| G | 0.000E+00 | −4.680E−09 | 4.506E−12 | −2.780E−11 | −3.708E−11 |
| H | 0.000E+00 | 2.057E−09 | −9.547E−13 | 1.839E−12 | 3.613E−13 |
| J | 0.000E+00 | −1.275E−10 | 2.540E−14 | 1.625E−13 | 3.213E−13 |

| Surface | | | | | |
|---|---|---|---|---|---|
| No. | S6 | S7 | S8 | S9 | S10 |
| K | 0.000E+00 | 0.000E+00 | −7.552E−02 | 2.650E−01 | −9.264E−01 |
| A | −1.167E−03 | −5.586E−04 | −8.107E−04 | −9.999E−04 | −3.696E−04 |
| B | −5.893E−05 | −4.645E−05 | −2.266E−05 | 8.299E−05 | 7.668E−05 |
| C | 2.701E−07 | −1.829E−08 | −1.919E−06 | 1.375E−05 | 3.288E−05 |
| D | 1.964E−07 | 3.587E−07 | 2.533E−08 | 4.874E−06 | 6.596E−06 |
| E | −1.227E−08 | 2.977E−08 | 1.963E−07 | 5.884E−07 | 4.247E−07 |
| F | −4.205E−09 | 6.521E−09 | 4.578E−08 | 6.671E−08 | |
| G | −7.507E−10 | 5.262E−10 | 4.170E−09 | 6.433E−09 | |
| H | −5.532E−11 | 2.086E−11 | −1.770E−10 | 2.006E−10 | |
| J | 1.169E−11 | −1.705E−11 | −2.157E−10 | −3.297E−10 | |

| Surface | | | | |
|---|---|---|---|---|
| No. | S11 | S12 | S13 | S14 |
| K | −2.574E+00 | 1.028E+00 | −8.371E+00 | −5.038E+00 |
| A | −1.904E−03 | −1.389E−03 | −4.040E−03 | −4.669E−03 |
| B | −6.826E−05 | 2.083E−04 | −1.180E−04 | 1.800E−05 |
| C | −3.085E−06 | −3.759E−05 | 1.160E−05 | 7.613E−06 |
| D | −4.140E−06 | −6.793E−06 | 4.839E−07 | 1.334E−08 |
| E | −6.835E−07 | 2.383E−07 | −1.546E−08 | −2.488E−08 |
| F | −3.243E−08 | 6.850E−09 | −3.753E−09 | −9.972E−10 |
| G | 4.134E−09 | −4.105E−09 | 1.393E−14 | 1.955E−10 |
| H | 2.000E−09 | 2.285E−09 | −3.087E−12 | −1.107E−11 |
| J | −1.440E−10 | −1.124E−10 | 8.221E−13 | 2.843E−13 |

The optical imaging system 700 according to the seventh embodiment of the present disclosure may have aberration characteristics as illustrated in FIG. 14.

Values of various characteristics of the optical imaging systems 100 to 700 according to the first to fourth embodiments of the present disclosure are illustrated in Table 15 below.

TABLE 15

| | Embodiment 1 | Embodiment 2 | Embodiment 3 | Embodiment 4 |
|---|---|---|---|---|
| f | 18.1143 | 12.1159 | 15.0006 | 14.9987 |
| f1 | 54.9119 | −7.3216 | 11.1815 | −8.0567 |
| f2 | 9.5602 | 3.8427 | 34.4981 | 4.9786 |
| f3 | −7.0957 | 12.0127 | −4.9792 | 20.4411 |
| f4 | 6.8060 | −12.2607 | 30.6857 | 103.4323 |
| f5 | −8.4097 | −15.4660 | −13.5961 | −8.0309 |
| f6 | — | — | 6.3621 | 81.0870 |
| f7 | — | — | — | — |
| TTL | 18.938 | 13.163 | 18.621 | 15.070 |
| BFL | 10.264 | 9.158 | 11.663 | 7.551 |
| IMG HT | 3.2 | 3.2 | 3.73 | 4.2 |
| f12 | 8.1922 | 7.5712 | 7.9732 | 11.8083 |
| TTL/(2 × IMG HT) | 2.959 | 2.057 | 2.496 | 1.794 |
| \|v1-Avg(v2, v3)\| | 16.25 | 16.25 | 34.35 | 14.85 |
| n2 + n3 | 3.192 | 3.192 | 3.325 | 3.158 |
| TTL/f | 1.0455 | 1.0864 | 1.2414 | 1.0048 |
| f-TTL_2 | 0.3763 | −0.4471 | −2.6204 | 0.6287 |
| \|f1/f\| | 3.0314 | 0.6043 | 0.7454 | 0.5372 |
| \|f1/f2\| | 5.7438 | 1.9053 | 0.3241 | 1.6183 |
| f12/f | 0.4523 | 0.6249 | 0.5315 | 0.7873 |
| D1/f | 0.0110 | 0.0083 | 0.0133 | 0.0067 |
| \|R1/f\| | Infinity | Infinity | Infinity | Infinity |
| \|f/f2 + f/f3\| | 4.4476 | 4.1616 | 3.4475 | 3.7464 |
| \|R1\| | Infinity | Infinity | Infinity | Infinity |
| \|(R1 + R2)/ | 1.0000 | 1.0000 | 1.0000 | 1.0000 |
| (R1 − R2)\| | | | | |

| | Embodiment 5 | Embodiment 6 | Embodiment 7 |
|---|---|---|---|
| f | 17.3776 | 14.9999 | 15.0000 |
| f1 | −11.1815 | −11.1703 | −9.2944 |
| f2 | 5.0499 | 5.7492 | 5.8191 |
| f3 | −5.0408 | −6.0387 | −5.8553 |
| f4 | 13.7886 | 14.4062 | 5.7678 |
| f5 | −48.5825 | 13.2177 | 31.5244 |
| f6 | 12.6282 | 105.9863 | −16.3263 |
| f7 | — | −69.4530 | −74.2734 |
| TTL | 20.004 | 17.813 | 16.182 |
| BFL | 12.899 | 5.737 | 5.672 |
| IMG HT | 4.2 | 5.4 | 5.4 |
| f12 | 8.778 | 11.4392 | 14.7710 |
| TTL/(2 × IMG HT) | 2.381 | 1.649 | 1.498 |
| \|\|v1-Avg(v2, v3)\| | 14.85 | 16.1 | 16.1 |
| n2 + n3 | 3.158 | 3.183 | 3.183 |
| TTL/f | 1.1511 | 1.1875 | 1.0788 |
| f-TTL_2 | −2.1264 | −1.9131 | −0.4820 |
| \|f1/f\| | 0.6434 | 0.7447 | 0.6196 |
| \|f1/f2\| | 2.2142 | 1.9429 | 1.5972 |
| f12/f | 0.5051 | 0.7626 | 0.9847 |
| D1/f | 0.0058 | 0.0067 | 0.0067 |
| \|R1/f\| | Infinity | Infinity | Infinity |
| \|f/f2 + f/f3\| | 6.8886 | 5.0930 | 5.1395 |
| \|R1\| | Infinity | Infinity | Infinity |
| \|(R1 + R2)/ | 1.0000 | 1.0000 | 1.0000 |
| (R1 − R2)\| | | | |

In Table 15, f1 a focal length of the first lens, f2 is a focal length of the second lens, f3 is a focal length of the third lens, f4 is a focal length of the fourth lens, f5 is a focal length of the fifth lens, f6 is a focal length of the sixth lens, and f7 is a focal length of the seventh lens. BFL is a distance along the optical axis from an image-side surface of the last lens (a fifth, sixth, or seventh lens) to the imaging plane.

As set forth above, according to an embodiment of the present disclosure, an optical imaging system that can implement a high resolution while being slim is provided.

While this disclosure includes specific examples, it will be apparent after an understanding of the disclosure of this application that various changes in form and detail may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a plurality of lenses sequentially disposed along an optical axis of the optical imaging system from an object side of the plurality of lenses toward an imaging plane of the optical imaging system; and
a reflective member disposed in front of the plurality of lenses and comprising a reflective surface,
wherein the plurality of lenses comprises a first lens disposed closest to the reflective member, and a second lens disposed adjacent to the first lens on an image side of the first lens,
a composite focal length f12 of the first lens and the second lens has a positive value, and
a conditional expression 0.9<|(R1+R2)/(R1−R2)|<1.1 is satisfied, where R1 is a radius of curvature of an object-side surface of the first lens at the optical axis, and R2 is a radius of curvature of an image-side surface of the first lens at the optical axis.

2. The optical imaging system of claim 1, wherein a conditional expression 500 mm<|R1| is satisfied.

3. The optical imaging system of claim 1, wherein the object-side surface of the first lens is flat in at least a paraxial region thereof.

4. The optical imaging system of claim 3, wherein an entire object-side surface of the first lens is flat.

5. The optical imaging system of claim 1, wherein a conditional expression 25<|R1/f| is satisfied, where f is a total focal length of the optical imaging system.

6. The optical imaging system of claim 1, wherein a conditional expression 1.00<TTL/(2×IMG HT)<1.70 is satisfied, where TTL is a distance along the optical axis from the object-side surface of the first lens to the imaging plane, and IMG HT is one half of a diagonal length of the imaging plane.

7. The optical imaging system of claim 1, wherein a conditional expression 0.95<TTL/f<1.3 is satisfied, where TTL is a distance along the optical axis from the object-side surface of the first lens to the imaging plane, and f is a total focal length of the optical imaging system.

8. The optical imaging system of claim 1, wherein the plurality of lenses further comprises a third lens disposed adjacent to the second lens on an image side of the second lens, and
a conditional expression 12<|v1−Avg(v2,v3)|<35 is satisfied, where v1 is an Abbe number of the first lens, and Avg(v2,v3) is an average value of an Abbe number of the second lens and an Abbe number of the third lens.

9. The optical imaging system of claim 1, wherein the plurality of lenses further comprises a third lens disposed adjacent to the second lens on an image side of the second lens, and
a conditional expression 3.15<n2+n3<3.4 is satisfied, where n2 is a refractive index of the second lens, and n3 is a refractive index of the third lens.

10. The optical imaging system of claim 1, wherein the plurality of lenses further comprises a third lens disposed adjacent to the second lens on an image side of the second lens, and
a conditional expression 3.3<|f/f2+f/f3|<7.0 is satisfied, where f2 is a focal length of the second lens, f3 is a focal length of the third lens, and f is a total focal length of the optical imaging system.

11. The optical imaging system of claim 1, wherein a conditional expression −3.00<f−TTL_2<1.00 is satisfied, where f is a total focal length of the optical imaging system, and TTL_2 is a distance along the optical axis from an object-side surface of the second lens to the imaging plane.

12. The optical imaging system of claim 1, wherein a conditional expression 0.3<|f1/f|<3.1 is satisfied, where f1 is a focal length of the first lens, and f is a total focal length of the optical imaging system.

13. The optical imaging system of claim 1, wherein a conditional expression 0.2<|f1/f2|<6.0 is satisfied, where f1 is a focal length of the first lens, and f2 is a focal length of the second lens.

14. The optical imaging system of claim 1, wherein a conditional expression 0.3<f12/f<1.0 is satisfied, where f12 is a composite focal length of the first lens and the second lens, and f is a total focal length of the optical imaging system.

15. The optical imaging system of claim 1, wherein a conditional expression 0.002<D1/f<0.03 is satisfied, where D1 is a distance along the optical axis between an image-side surface of the first lens and an object-side surface of the second lens.

16. The optical imaging system of claim 1, wherein the second lens has a positive refractive power.

17. The optical imaging system of claim 1, wherein the plurality of lenses further comprises a third lens, a fourth lens, and a fifth lens,
the first lens, the second lens, the third lens, the fourth lens, and the fifth lens are sequentially disposed in ascending numerical order along the optical axis from an object side of the first lens toward the imaging plane, and
the second lens has a positive refractive power, and the fifth lens has a negative refractive power.

18. The optical imaging system of claim 1, wherein the plurality of lenses further comprises a third lens, a fourth lens, a fifth lens, and a sixth lens,
the first lens, the second lens, the third lens, the fourth lens, the fifth lens, and the sixth lens are sequentially disposed in ascending numerical order along the optical axis from an object side of the first lens toward the imaging plane, and
the second lens has a positive refractive power, the fourth lens has a positive refractive power, the fifth lens has a negative refractive power, and the sixth lens has a positive refractive power.

19. The optical imaging system of claim 1, wherein the plurality of lenses further comprises a third lens, a fourth lens, a fifth lens, a sixth lens, and a seventh lens,
the first lens, the second lens, the third lens, the fourth lens, the fifth lens, the sixth lens, and the seventh lens are sequentially disposed in ascending numerical order along the optical axis from an object side of the first lens toward the imaging plane, and
the first lens has a negative refractive power, the second lens has a positive refractive power, the third lens has a negative refractive power, the fourth lens has a positive refractive power, the fifth lens has a positive refractive power, and the seventh lens has a negative refractive power.
